(19) United States
(12) Patent Application Publication
(10) Pub. No.: US 2023/0047123 A1
(43) Pub. Date: Feb. 16, 2023

(54) Video Processing Systems and Methods

(71) Applicant: Lifecast Incorporated, Menlo Park, CA (US)

(72) Inventor: Forrest Briggs, Palo Alto, CA (US)

(21) Appl. No.: 17/979,514

(22) Filed: Nov. 2, 2022

Related U.S. Application Data
(63) Continuation-in-part of application No. 17/867,036, filed on Jul. 18, 2022.
Application No. 17/867,036 is a continuation-in-part of application No. 17/961,051, filed on Oct. 6, 2022.
(60) Provisional application No. 63/274,831, filed on Nov. 2, 2021.

(51) Int. Cl. G06T 5/00; G06T 15/20

(52) U.S. Cl. CPC G06T 5/006; G06T 15/20; G06T 2207/10016

(57) ABSTRACT

Example video processing systems and methods are described. In one implementation, compressed video data is received from a recording device. Additionally, metadata associated with the compressed video data is received such that the metadata includes frame-specific metadata associated with frames in the compressed video data. Further, an application program is received and configured to generate a real-time interactive experience for a user based on the compressed video data and the metadata associated with the compressed video data. A non-fungible token (NFT) is generated that includes the compressed video data, the metadata associated with the compressed video data, and the application program.

### RELATED APPLICATIONS

This application is a Continuation in Part of U.S. application Ser. No. 17/867,036, filed on Jul. 18, 2022, the disclosure of which is incorporated herein by reference in its entirety. This application is also a Continuation in Part of U.S. application Ser. No. 17/961,051, filed on Oct. 6, 2022, the disclosure of which is incorporated herein by reference in its entirety. This application also claims the priority benefit of U.S. Provisional Application Ser. No. 63/274,831, filed on Nov. 2, 2021, the disclosure of which is incorporated herein by reference in its entirety.

### TECHNICAL FIELD

The present disclosure relates to systems and methods that perform video processing for various types of systems.

### BACKGROUND

A non-fungible token (NFT) is a type of smart contract, which is typically stored and executed in a blockchain, which represents one or more copies of a unique digital object. NFTs may be “minted” (e.g., created), bought, sold, and traded. The protocol of a specific blockchain maintains a record of ownership that is resilient to double-spend attacks and censorship. Many cryptographic digital assets are fungible (i.e., 1 ETH or 1 BTC is interchangeable for another), whereas NFTs are not fungible (i.e., each NFT represents a unique thing which is not equivalent to any other thing). NFTs are commonly used to represent images, photos, and videos. In some cases, NFTs also represent programs which can be executed in a web browser to produce dynamic or interactive content. This latter type of NFT may be programmed in Javascript or a compatible language that runs in a web browser. In some cases, an NFT may represent a bundle of data and files.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram illustrating an environment within which an example embodiment may be implemented.

FIG. 2 is a block diagram illustrating an embodiment of a computing system.

FIG. 3 is a flow diagram illustrating an embodiment of a non-fungible token (NFT).

FIG. 4 is a flow diagram illustrating an embodiment of a process for capturing photo data, video data, and other sensor data, then generating an NFT that includes the photo data, video data, other sensor data, and a video player application.

FIG. 5 illustrates an embodiment of a process for generating an NFT based on received compressed video data, metadata, and an application program.

FIG. 6 illustrates an embodiment of a marketplace or collection of content represented by thumbnail images that link to specific items of content.

FIG. 7 illustrates an embodiment of an avatar in the metaverse that interacts with a picture frame that is part of a shared virtual world.

FIG. 8 illustrates an example block diagram of a computing device.

### DETAILED DESCRIPTION

In some embodiments, the systems and methods described herein perform various image capture, image processing, image rendering, and related activities. In particular implementations, the described systems and methods are associated fields of virtual reality, mixed reality, augmented reality, video, volumetric video, 6 DOF (degrees of freedom) video, metaverse, cryptography, and non-fungible tokens (NFTs).

In some embodiments, the described systems and methods include a recording device, such as a wearable recording device, that captures images and other data. Rendering software processes the images and other data to produce a 3D video from, for example, the recording device wearer's point of view (POV). Player software may decode the 3D video so that it can be displayed on a 2D screen or head-mounted display, thereby producing the experience for the viewer of re-living the recorded experience. In some embodiments, the 3D video and/or player software may be packaged as an NFT.

In the following disclosure, reference is made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter is described in language specific to structural features and/or methodological acts, it is to be understood that the subject matter defined in the appended claims is not necessarily limited to the described features or acts described herein. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed herein may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein for purposes of illustration, and are not intended to be limiting. Embodiments of the present disclosure may be implemented in further types of devices, as would be known to persons skilled in the relevant art(s).

At least some embodiments of the disclosure are directed to computer program products comprising such logic (e.g., in the form of software) stored on any computer useable medium. Such software, when executed in one or more data processing devices, causes a device to operate as described herein.

In some virtual reality (VR) environments, a user may wear a head-mounted display, which shows images that create the effect of 3D for the user, and (ideally), a sense of immersion and presence in the virtual scene. Virtual reality is related to augmented reality and mixed reality, where the user sees a combination of real and virtual worlds. The metaverse is a loosely defined concept related to virtual reality, which includes a shared virtual space where users can interact with virtual objects using metaphors inspired by physical reality. Some experiences in the metaverse include interacting with photos or videos, or visiting places or moments from the past, present, or future. Ownership of virtual objects in the metaverse can be represented by NFTs.

In some embodiments, it is possible to view traditional 2D photos and videos in VR or the metaverse, but there are also specific formats of 3D photo and video designed for VR, which create a greater sense of immersion and presence for the viewer. For example, some photos and videos for VR are stereoscopic, which produces an approximation of 3D perception for the user. There are also formats for 3D VR video and photos which provide 6 degrees of freedom (6DOF) to translate and rotate the view, which enables a more immersive experience by reacting correctly to motion of the viewer's head-mounted display. Some formats for 6DOF VR video involve storing a video plus an associated depth map.

In some implementations, wearable cameras can capture photos and video from a user's point of view (POV). POV video is a genre of video in general. POV video can be watched in VR to create an immersive experience similar to re-living the memory of the recorded moment, although special care must be taken to avoid causing motion sickness to the viewer.

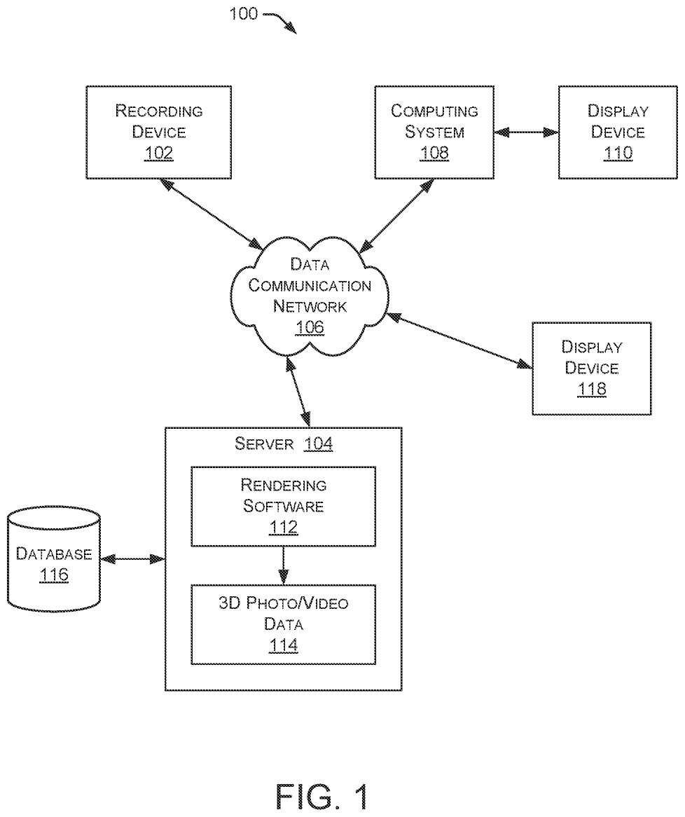

FIG. 1 is a block diagram illustrating an environment 100 within which an example embodiment may be implemented. As shown in FIG. 1, a recording device 102 is coupled to communicate with a server 104 and a computing system 108 via a data communication network 106. Recording device 102 may record audio data, photo data, video data, and other sensor data. In some embodiments, recording device 102 may be a wearable device that is worn by a user, such as a pair of glasses, a pin, or a helmet. In some embodiments, the recording device may have additional functionality, such as virtual reality or augmented reality glasses. In particular implementations, recording device 102 includes one or more cameras that record video and, in some situations, additional sensors that include inertial measurement units (IMUs), microphones, or lidar. In some embodiments, recording device 102 may have onboard storage to save the captured data. Additionally, recording device 102 may have internet connectivity and may stream the recorded data to a remote server live. The recording device may further have a physical or virtual user interface that enables the user to control the recording.

Server 104 performs various operations, such as executing rendering software 112, which generates 3D photo/video data 114, and the like. Server 104 may access a database 116 to store and retrieve various types of data, such as 3D photo/video data 114. In some implementations, 3D photo/video data 114 may be compressed and/or encoded.

In some embodiments, rendering software 112 processes the data collected by recording device 102 to produce a 3D photo/video file and optional metadata. Rendering software 112 may use images and/or IMU measurements to estimate the motion of recording device 102 with respect to an external coordinate frame (e.g., visual-inertial odometry). Rendering software 112 may use any suitable method in the field of computer vision to produce a 3D representation of the scene, which could be a photo or a video, in which case the representation may vary as a function of time. For example, images may be processed to produce a 3D scene representation by a stereo disparity algorithm, multi-view stereo algorithm, photogrammetry, neural scene representation, and the like. In some embodiments, rendering software 112 encodes the (time-varying) 3D scene representation in a compressed format, which is suitable for efficient transmission over the internet and efficient decoding by player software, discussed herein.

In some embodiments, rendering software 112 is optimized for data collected from a moving recording device (as would be the case if the device is worn), such that its output makes some modifications to minimize vestibulo-ocular conflict. When minimizing vestibulo-ocular conflict, when a viewer watches the 3D video in virtual reality, it does not cause motion sickness. For example, horizon stabilization is one type of modification that fits this description, although others exist.

In some embodiments, 3D photo/video data 114 consists of an image in a standard format (e.g., jpeg or png), a video in a standard format (e.g., mp4 or mov), a triangle mesh, the parameters of a neural network or differentiable computation graph, and/or additional metadata such as text, JSON, protobuf, or arbitrary binary data. In some implementations, the image or video is partitioned into regions with different purposes. For example, one region may store color images, while another region stores alpha, depth or inverse depth information (potentially for multiple layers of a scene).

Computing system 108 performs various operations related to processing 3D photo/video data 112, generating NFTs, managing display devices, and the like as discussed herein. A display device 110 is coupled to computing system 108 for presenting video data to a user. Display device 110 may include a computer screen, VR headset, AR headset, and the like. Another display device 118 may also receive video data from computing system 108 via data communication network 106. Although two display devices 110, 118 are shown in FIG. 1, particular embodiments may include any number of display devices that receive video data from one or more computing systems 108.

In some embodiments, data communication network 106 includes any type of network topology using any communication protocol. Additionally, data communication network 106 may include a combination of two or more communication networks. In some implementations, data communication network 106 includes a cellular communication network, the Internet, a local area network, a wide area network, or any other communication network. In environment 100, data communication network 106 allows communication between server 104, computing system 108, and any number of other systems, devices, and the like.

It will be appreciated that the embodiment of FIG. 1 is given by way of example only. Other embodiments may include fewer or additional components without departing from the scope of the disclosure. Additionally, illustrated components may be combined or included within other components without limitation.

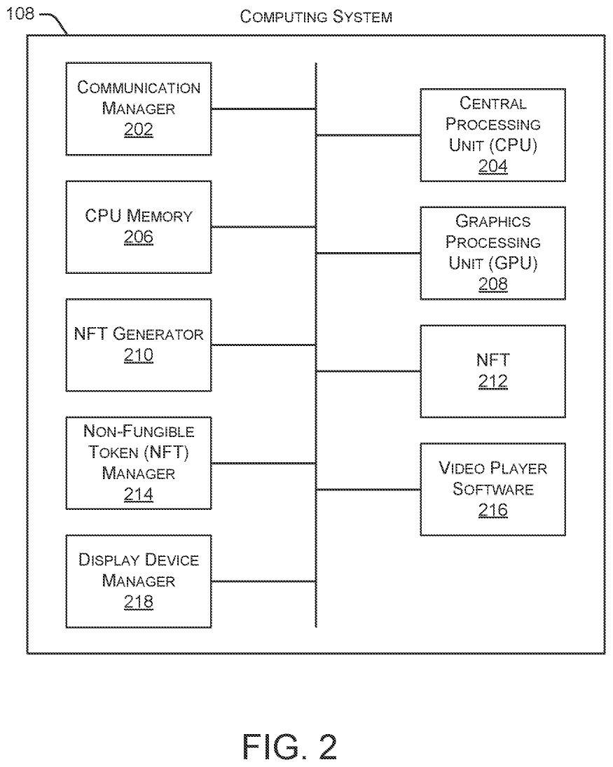

FIG. 2 is a block diagram illustrating an embodiment of computing system 108. As shown in FIG. 2, computing system 108 may include a communication manager 202, a CPU 204, a CPU memory 206, and a GPU 208. Communication manager 202 allows computing system 108 to communicate with other systems, such as recording device 102 and server 104 shown in FIG. 1, and the like.

CPU 204 and GPU 208 can execute various instructions to perform the functionality provided by computing system 108, as discussed herein. CPU memory 206 may store these instructions as well as other data used by CPU 204, GPU 208, and other modules and components contained in computing system 108. In particular implementations, GPU 208 processes 3D photo video data 114 received from server 104. This processing may include decompressing or decoding 3D photo video data 114.

Additionally, computing system 108 may include an NFT generator 210 that generates various NFTs 212 that include different information. As discussed herein, NFT generator 210 may generate NFTs 212 that include 3D photo/video data 114, a video player application, and metadata. In some embodiments, a particular NFT 212 may represent a memory that includes, for example, various images and sounds associated with a first-person perspective or point of view. A particular memory may have been captured by a specific person, at a particular time, and in a particular environment. A memory allows any user to re-live the memory by experiencing the same sounds and images as the person who created the memory. For example, a memory may be captured (e.g., created) by a celebrity, sports star, or anyone else who wants to create a memory. As discussed herein, that memory may be included in an NFT and sold or otherwise transferred to one or more other people who can re-live that memory themselves from the perspective of the original person who captured the memory.

Additionally, computing system 108 may include an NFT manager 214 that manages various NFTs 212 and may handle the distribution of NFTs 212 to other computing systems, other users, NFT marketplaces, and the like. Video player software 216 can play or render various types of video data, such as 3D photo/video data 114. The played or rendered video data generated by video player software 216 may be communicated to a display device (e.g., display device 110 or 118), other computing systems, and the like. A display device manager 218 manages any number of display devices and the display of information, such as video information, on one or more display devices. Additionally, display device manager 218 may coordinate the communication of video information to particular display devices.

In some embodiments, computing system 108 decodes 3D photo/video data 114 using GPU 208 or similar graphics acceleration hardware, which is typically programmed using a graphics API (e.g., OpenGL). The video display software executes code that produces a display image on a display device, such as a 2D screen or head-mounted display.

Typically, this involves executing commands in the graphics API which construct “geometry” consisting of vertices with vertex attribute data, then rendering the geometry with a graphics draw command, a vertex shader, and a fragment shader. In some embodiments, the display software precomputes some generic geometry, then decodes the 3D photo/video data into a texture which is accessible to vertex and fragment shaders. The vertex shaders deform the precomputed geometry by sampling depth information from the texture. The fragment shaders compute a color for each pixel on the display device by sampling color information from the texture.

In some embodiments, the display device is a head-mounted display which tracks its motion in 6 DOF, and makes its current pose available to the vertex and fragment shaders via a uniform variable. The vertex shader typically transforms the geometry using this pose so that the rendered scene responds to the user's head movement.

In some embodiments, frame-specific metadata is synchronized with a video, and copied into the vertex and fragment shader uniforms, then used as part of rendering. For example, frame-specific metadata might contain a rotation or 4×4 transform to be applied to the geometry in each frame, which undoes the motion of the recording device relative to the viewer in VR. This technique is important for minimizing vestibulo-ocular conflict when the recording device is wearable and/or captures video from the wearer's point of view.

In some embodiments, the display software is written in Javascript or any other language which can be executed in a web browser. For example, the display software may be one or more files or Javascript code which are executed by a browser as part of displaying a web page. The in-browser display software renders using graphics acceleration hardware and a graphics API such as OpenGL. The in-browser display software loads or streams the 3D photo/video data, and possibly additional metadata.

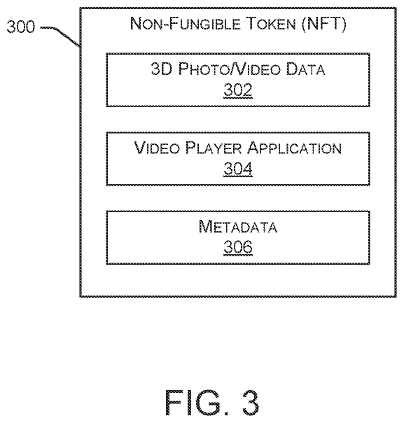

FIG. 3 is a flow diagram illustrating an embodiment of a non-fungible token (NFT) 300. In some embodiments, NFT 300 may be used in a virtual reality environment, an augmented reality environment, a mixed reality environment, a metaverse environment, and the like. In a particular implementation, NFT 300 may represent a region of space-time in an environment such as a metaverse. As discussed herein, NFT 300 may be available for purchase in an NFT marketplace or other marketplace. In some implementations, NFT 300 may be sold as an object in the metaverse or other environment. In particular embodiments, NFT 300 may appear as part of a collection in the metaverse.

As shown in FIG. 3, a particular NFT 300 may include 3D photo/video data 302 (e.g., 3D photo/video data 114 generated by rendering software 112), a video player application 304, and metadata 306. Thus, NFT 300 contains 3D photo/video data 302 and the necessary video player application 304 to play the 3D photo/video data. Therefore, NFT 300 does not need an external video player application (e.g., external to the NFT) to play 3D photo/video data 302 contained in NFT 300. In some embodiments, playback of NFT 300 is initiated based on another object, a link, a trigger within an environment, and the like. In particular implementations, NFT 300 may include an index file (e.g., index.html file) that may identify the items in NFT 300.

Metadata 306 may be associated with 3D photo/video data 302 and can include a rotation matrix, a 4×4 transformation matrix, or other parameterization of a pose used to transform the 3D geometry of a scene to counteract camera motion and minimize vestibulo-ocular conflict. Metadata 306 may also include parameters of a neural network or differentiable computation graph that is responsible for at least partially rendering views of a 3D scene.

In some embodiments, the NFT (e.g., NFT 300) is a token on the Ethereum blockchain (e.g., ERC-721) or any other blockchain suitable for constructing NFTs (e.g., Tezos, Solana, Polkadot, and the like).

In some embodiments, the NFT can bundle a set of files and/or directories as associated data (for example, the NFT platform Hic Et Nunc supports creating NFTs with this structure). This may include one or more .html files which define a webpage or iframe content and/or embedded Javascript, one or more separate Javascript files, the 3D photo/video data, and optional additional metadata. The NFT includes sufficient data as described herein to provide a complete system for replay of the 3D photo/video data on a 2D screen or head-mounted display, including both the data and a copy of the player software. Typical NFTs represent only an image or video, whereas the systems and methods described herein may also include the player software as part of the NFT.

In some implementations, the player software is not part of the NFT (only the 3D photo/video data is part of the NFT), while in other embodiments the player software is part of the NFT.

In some embodiments, the ultimate capability afforded by the described systems and methods is the ability to capture a 3D photo/video of an experience or memory from the point of view of the user of a wearable recording device. The systems and methods then create the feeling of re-living the recorded experience when watched in VR and package all of the data and software necessary for replay in an NFT. In other words, the described systems and methods may include an NFT that represents a memory or experience as well as the necessary data and software to enable a person to replay the memory or experience in VR without requiring any outside software or applications (e.g., video players).

In some embodiments, NFT 300 represents an NFT for 3D VR video or immersive volumetric video. For example, immersive volumetric video may include an NFT that includes a 3D video representation and player for 3D or VR environments.

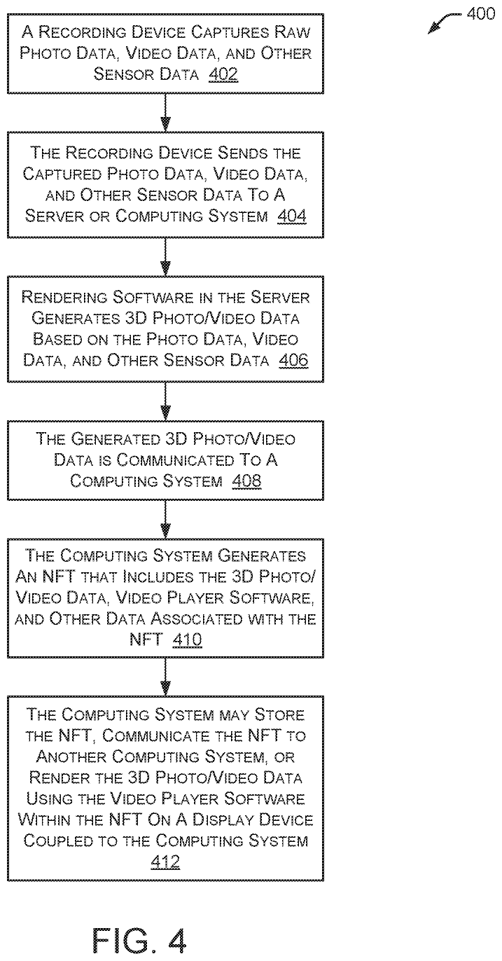

FIG. 4 is a flow diagram illustrating an embodiment of a process 400 for capturing photo data, video data, and other sensor data, then generating an NFT that includes the photo data, video data, other sensor data, and a video player application. Initially, a recording device captures 402 raw photo data, video data, and other sensor data. As discussed herein, sensor data may include cameras, IMUs, microphones, or lidar.

Process 400 continues as the recording device sends 404 the captured photo data, video data, and other sensor data to a server or computing system. Rendering software in a server then generates 406 3D photo/video data based on the photo data, video data, and other sensor data. The generated 3D photo/video data is communicated 408 to a computing system or other device for processing. The computing system receives the 3D photo/video data and generates 410 an NFT that includes the 3D photo/video data, video player software, and other data associated with the NFT. The other data associated with the NFT includes various metadata discussed herein. Finally, the computing system may store 412 the NFT, communicate the NFT to another computing system, or render the 3D photo/video data using the video player software within the NFT on a display device coupled to the computing system or otherwise accessible to the computing system.

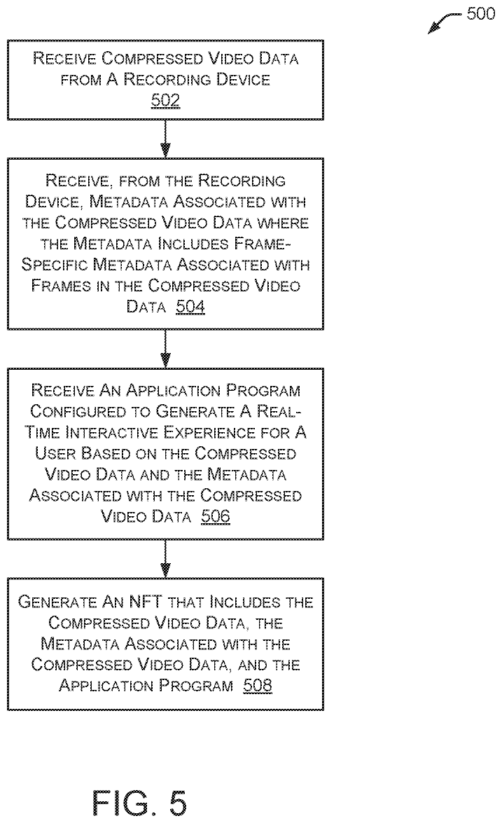

FIG. 5 illustrates an embodiment of a process 500 for generating an NFT based on received compressed video data, metadata, and an application program. Initially, process 500 receives 502 compressed video data from a recording device. The process continues by receiving 504, from the recording device, metadata associated with the compressed video data. In some embodiments, the metadata includes frame-specific metadata associated with frames in the compressed video data. Process 500 continues by receiving 506 an application program configured to generate a real-time interactive experience for a user based on the compressed video data and the metadata associated with the compressed video data. Finally, the process generates 508 an NFT that includes the compressed video data, the metadata associated with the compressed video data, and the application program.

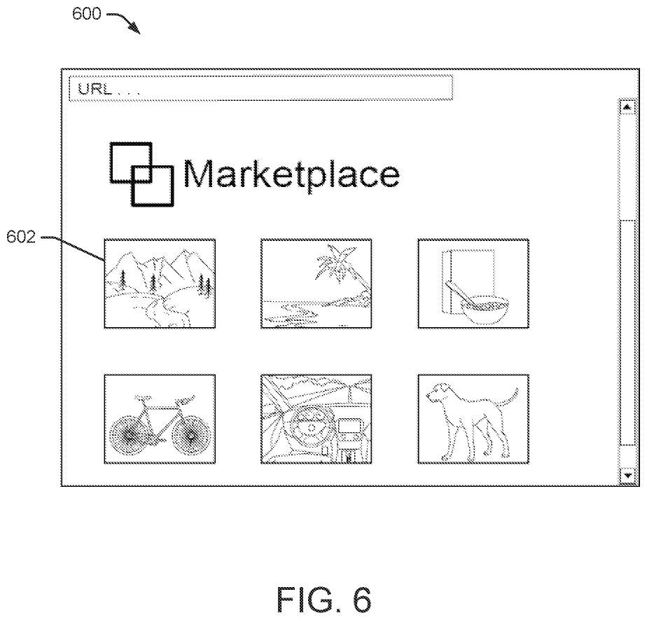

FIG. 6 illustrates an embodiment of a marketplace 600 or collection of content represented by thumbnail images 602 that link to specific items of content. The specific items of content in marketplace 600 may include NFTs for 3D POV videos and other types of content. In some embodiments, as a user scrolls through the content in marketplace 600 (e.g., using a mouse or other input device), the thumbnail images 602 may change how they are rendered to show motion parallax based on the depth information in the NFT. For example, an NFT's data and software may cause a preview of the photo or video to be rendered in marketplace 600. In some implementations, the motion parallax may cause each thumbnail to look like a small window into a 3D world behind the thumbnail.

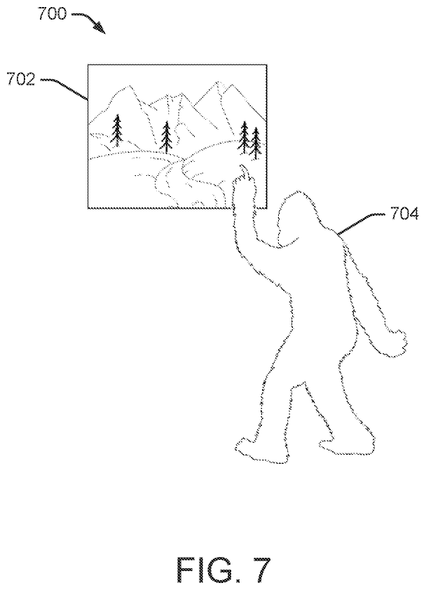

FIG. 7 illustrates an embodiment of an environment 700 that includes an avatar 704 in the metaverse that interacts with a picture frame 702 that is part of a shared virtual world. A user is controlling avatar 704 within environment 700. Additionally, the user owns an NFT that can be used in environment 700. When the user causes avatar 704 to interact with picture frame 702, avatar 704 is transported into the recorded experience or memory represented by the NFT. In some implementations, environment 700 might initially contain any type of 3D content related to (or unrelated to) the NFT. When the user causes avatar 704 to interact with picture frame 702, the original scene fades away or may be replaced with another visually appealing transition, with the content of the NFT. In some embodiments, the NFT does not replace the entire environment 700. Instead, the NFT replaces a portion of environment 700.

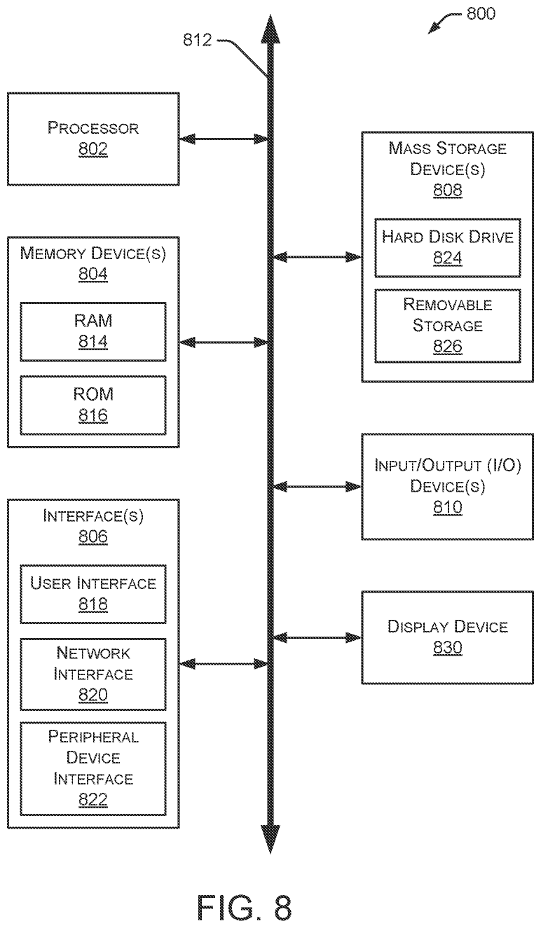

FIG. 8 illustrates an example block diagram of a computing device 800 suitable for implementing the systems and methods described herein. In some embodiments, a cluster of computing devices interconnected by a network may be used to implement any one or more components of the systems discussed herein.

Computing device 800 may be used to perform various procedures, such as those discussed herein. Computing device 800 can function as a server, a client, or any other computing entity. Computing device 800 can perform various functions as discussed herein, and can execute one or more application programs, such as the application programs described herein. Computing device 800 can be any of a wide variety of computing devices, such as a desktop computer, a notebook computer, a server computer, a handheld computer, tablet computer and the like.

Computing device 800 includes one or more processor(s) 802, one or more memory device(s) 804, one or more interface(s) 806, one or more mass storage device(s) 808, one or more Input/Output (I/O) device(s) 810, and a display device 830 all of which are coupled to a bus 812. Processor(s) 802 include one or more processors or controllers that execute instructions stored in memory device(s) 804 and/or mass storage device(s) 808. Processor(s) 802 may also include various types of computer-readable media, such as cache memory.

Memory device(s) 804 include various computer-readable media, such as volatile memory (e.g., random access memory (RAM) 814) and/or nonvolatile memory (e.g., read-only memory (ROM) 816). Memory device(s) 804 may also include rewritable ROM, such as Flash memory.

Mass storage device(s) 808 include various computer readable media, such as magnetic tapes, magnetic disks, optical disks, solid-state memory (e.g., Flash memory), and so forth. As shown in FIG. 8, a particular mass storage device is a hard disk drive 824. Various drives may also be included in mass storage device(s) 808 to enable reading from and/or writing to the various computer readable media. Mass storage device(s) 808 include removable media 826 and/or non-removable media.

I/O device(s) 810 include various devices that allow data and/or other information to be input to or retrieved from computing device 800. Example I/O device(s) 810 include cursor control devices, keyboards, keypads, microphones, monitors or other display devices, speakers, printers, network interface cards, modems, lenses, CCDs or other image capture devices, and the like.

Display device 830 includes any type of device capable of displaying information to one or more users of computing device 800. Examples of display device 830 include a monitor, display terminal, video projection device, and the like.

Interface(s) 806 include various interfaces that allow computing device 800 to interact with other systems, devices, or computing environments. Example interface(s) 806 include any number of different network interfaces 820, such as interfaces to local area networks (LANs), wide area networks (WANs), wireless networks, and the Internet. Other interface(s) include user interface 818 and peripheral device interface 822. The interface(s) 806 may also include one or more user interface elements 818. The interface(s) 806 may also include one or more peripheral interfaces such as interfaces for printers, pointing devices (mice, track pad, etc.), keyboards, and the like.

Bus 812 allows processor(s) 802, memory device(s) 804, interface(s) 806, mass storage device(s) 808, and I/O device(s) 810 to communicate with one another, as well as other devices or components coupled to bus 812. Bus 812 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 800, and are executed by processor(s) 802. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

While various embodiments of the present disclosure are described herein, it should be understood that they are presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the described exemplary embodiments, but should be defined only in accordance with the following claims and their equivalents. The description herein is presented for the purposes of illustration and description. It is not intended to be exhaustive or to limit the disclosure to the precise form disclosed. Many modifications and variations are possible in light of the disclosed teaching. Further, it should be noted that any or all of the alternate implementations discussed herein may be used in any combination desired to form additional hybrid implementations of the disclosure.

1. A method comprising:
receiving, from a recording device, compressed video data;
receiving, from the recording device, metadata associated with the compressed video data, wherein the metadata includes frame-specific metadata associated with frames in the compressed video data;
receiving an application program configured to generate a real-time interactive experience for a user based on the compressed video data and the metadata associated with the compressed video data; and
generating a non-fungible token (NFT) that includes the compressed video data, the metadata associated with the compressed video data, and the application program.

2. The method of claim 1, wherein the NFT represents a memory that includes a plurality of images and sounds associated with a first-person perspective, wherein the memory is generated by a first person.

3. The method of claim 2, wherein the memory is captured by the first person at a particular time and in a particular environment.

4. The method of claim 3, wherein the user re-lives the memory generated by the first person and experiences the same images and sounds as the first person.

5. The method of claim 1, wherein the NFT is configured to be used in at least one of a virtual reality environment, an augmented reality environment, a mixed reality environment, or a metaverse environment.

6. The method of claim 1, wherein the NFT represents a region of space-time in a metaverse environment.

7. The method of claim 1, wherein the NFT is available for purchase in an NFT marketplace.

8. The method of claim 1, wherein playback of the NFT is initiated based on at least one of another object, a link, or a trigger within an environment.

9. The method of claim 1, wherein the compressed video data represents three-dimensional (3D) image data or 3D photo data.

10. The method of claim 1, wherein the metadata associated with the compressed video data includes at least one of a rotation matrix, a 4×4 transformation matrix, or other parameterization of a pose used to transform the 3D geometry of a scene to counteract camera motion and minimize vestibulo-ocular conflict.

11. The method of claim 1, wherein the metadata associated with the compressed video data includes parameters of a neural network or differentiable computation graph that is responsible for at least partially rendering views of a 3D scene.

12. An apparatus comprising:
one or more processors; and
one or more non-transitory computer-readable media storing instructions executable by the one or more processors, wherein the instructions, when executed, cause the system to perform operations comprising:
receiving compressed video data;
receiving metadata associated with the compressed video data, wherein the metadata includes frame-specific metadata associated with frames in the compressed video data;
receiving an application program configured to generate a real-time interactive experience for a user based on the compressed video data and the metadata associated with the compressed video data; and
generating a non-fungible token (NFT) that includes the compressed video data, the metadata associated with the compressed video data, and the application program.

13. The apparatus of claim 12, wherein the NFT represents a memory that includes a plurality of images and sounds associated with a first-person perspective, wherein the memory is generated by a first person.

14. The apparatus of claim 13, wherein the memory is captured by the first person at a particular time and in a particular environment.

15. The apparatus of claim 14, wherein the user re-lives the memory generated by the first person and experiences the same images and sounds as the first person.

16. The apparatus of claim 12, wherein the NFT is configured to be used in at least one of a virtual reality environment, a mixed reality environment, or a metaverse environment.

17. The apparatus of claim 12, wherein the metadata associated with the compressed video data includes at least one of a rotation matrix, a 4×4 transformation matrix, or other parameterization of a pose used to transform the 3D geometry of a scene to counteract camera motion and minimize vestibulo-ocular conflict.

18. The apparatus of claim 12, wherein the metadata associated with the compressed video data includes parameters of a neural network or differentiable computation graph that is responsible for at least partially rendering views of a 3D scene.

19. One or more non-transitory computer-readable media storing instructions that, when executed, cause one or more processors to perform operations comprising:
receiving compressed video data;
receiving metadata associated with the compressed video data, wherein the metadata includes frame-specific metadata associated with frames in the compressed video data;
receiving an application program configured to generate a real-time interactive experience for a user based on the compressed video data and the metadata associated with the compressed video data;
generating a non-fungible token (NFT) that includes the compressed video data, the metadata associated with the compressed video data, and the application program, wherein the NFT represents a memory that includes a plurality of images and sounds associated with a first-person perspective.

20. The one or more non-transitory computer-readable media of claim 19, wherein the metadata associated with the compressed video data includes at least one of a rotation matrix, a 4×4 transformation matrix, or other parameterization of a pose used to transform the 3D geometry of a scene to counteract camera motion and minimize vestibulo-ocular conflict.
